(19) United States
(12) Patent Application Publication
(10) Pub. No.: US 2022/0008943 A1
(43) Pub. Date: Jan. 13, 2022

(54) DISCHARGE CONTAINER

(71) Applicant: KAO CORPORATION, Tokyo (JP)

(72) Inventors: Takuma KIMURA, Sumida-ku (JP); Yoshinori INAGAWA, Sumida-ku (JP); Noboru YASHIMA, Sumida-ku (JP)

(73) Assignee: KAO CORPORATION, Tokyo (JP)

(21) Appl. No.: 17/295,550

(22) PCT Filed: Mar. 4, 2019
(86) PCT No.: PCT/JP2019/008460

§ 371 Date: May 20, 2021

(30) Foreign Application Priority Data
Nov. 29, 2018 (JP) 2018-223743

(51) Int. Cl. B05B 11/00; B05B 7/00; B65D 47/06

(52) U.S. Cl. CPC B05B 11/3087; B65D 47/06; B05B 7/0037

(57) ABSTRACT

A discharge container comprises a discharge head including a discharge port from which bubbles are to be discharged; and a discharge head attachment attached to the discharge head, wherein the discharge head attachment includes a cylindrical portion connected to the discharge port on one side and including a first opening on another side, and a porous portion provided on the one side of the cylindrical portion, a side portion of the cylindrical portion includes a second opening, and a peripheral edge of the first opening extends at least partially along a circumferential direction of the cylindrical portion.

### FIELD OF THE INVENTION

The present invention relates to a discharge container.

### BACKGROUND OF THE INVENTION

Conventionally, a discharge container for discharging liquid, such as a body wash, as bubbles has been widely used. Specifically, the liquid contained in the discharge container is mixed with a gas such as air to generate bubbles, and the bubbles thus generated are discharged from a discharge port formed in a discharge head of the discharge container.

For example, Patent Literature 1 discloses a technique of attaching an attachment to the discharge head and devising the shape of the attachment to improve the visual appeal of the bubbles discharged from the discharge container.

### CITATION LIST

### Patent Literature

Patent Literature 1: Japanese Patent Application Laid-Open No. 2018-052610

### DISCLOSURE OF INVENTION

### Technical Problem

However, the conventional technology such as the technique disclosed in Patent Literature 1 has failed to ensure sufficient shape retention property of the bubbles, and there has been room for improvement in the visual appeal of the bubbles.

In this regard, the present invention relates to an effective improvement in the visual appeal of the bubbles discharged from a discharge container.

### Solution to Problem

In order to solve the above problem, one aspect of the present invention relates to a discharge container comprising: a discharge head including a discharge port from which bubbles are to be discharged; and a discharge head attachment attached to the discharge head, wherein the discharge head attachment includes a cylindrical portion connected to the discharge port on one side and including a first opening on another side, and a porous portion provided on the one side of the cylindrical portion, a side portion of the cylindrical portion includes a second opening, and a peripheral edge of the first opening extends at least partially along a circumferential direction of the cylindrical portion.

### Advantageous Effects of Invention

As described above, according to the discharge container of the present invention, it is possible to effectively improve the visual appeal of the bubbles discharged from a discharge container.

### BRIEF DESCRIPTION OF THE DRAWINGS

FIG. 1 is a partial cross-sectional side view of a discharge container according to an embodiment of the present invention.

FIG. 2 is a perspective view of a discharge head attachment according to the embodiment.

FIG. 3 is a partial cross-sectional side view of the discharge head attachment according to the embodiment.

FIG. 4 is a diagram partially showing a porous portion provided in the discharge head attachment according to the embodiment.

FIG. 5 is a diagram schematically showing a foam formed using the discharge head attachment according to the embodiment.

FIG. 6 is a perspective view showing a discharge head attachment according to another embodiment different from the discharge head attachment shown in FIGS. 2 and 3.

FIG. 7 is a partial cross-sectional side view of the discharge head attachment according to the embodiment.

### DETAILED DESCRIPTION OF THE INVENTION

Hereinafter, suitable embodiments of the present invention will be described in detail with reference to the attached drawings. Note that, in this specification and drawings, components having substantially the same functional configurations are denoted by the same reference symbols, and repetitive description thereof is omitted.

The embodiments of the present invention relate to a discharge container. Specifically, a discharge container 1 according to an embodiment of the present invention is a discharge container that mixes liquid with air to generate bubbles and discharges the bubbles from a discharge port of a discharge head.

Note that description will be given below on the discharge container 1 that is a pump-type discharge container for discharging bubbles from a discharge port of a discharge nozzle when a pump mechanism operates in conjunction with the depression of the discharge nozzle, but the discharge container according to the present invention only needs to be one that discharges bubbles from the discharge port of the discharge nozzle and may be, for example, a squeeze-type discharge container for discharging bubbles from the discharge port of the discharge nozzle by squeezing the container main body.

<Overall Configuration of Discharge Container>

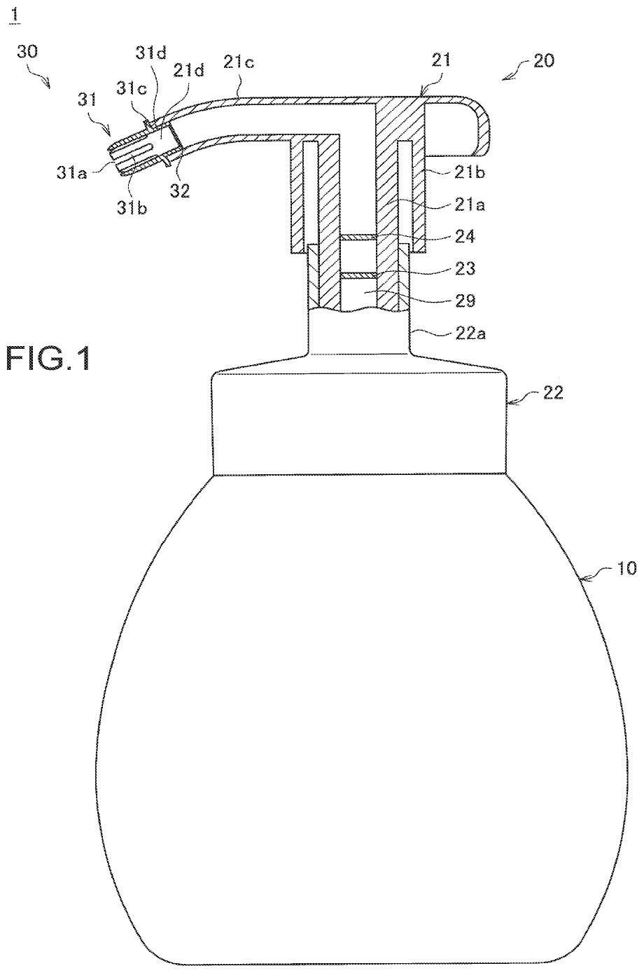

First, a configuration of the discharge container 1 according to an embodiment of the present invention will be described with reference to FIG. 1.

FIG. 1 is a partial cross-sectional side view of the discharge container 1.

Note that, in this specification, a direction from a container main body 10, which will be described later, to a dispenser 20 will be referred to as an upward direction for easy comprehension. Here, since the discharge container 1 can take various postures when used by a user, the direction from the container main body 10 to the dispenser 20 does not necessarily mean the vertical upward direction.

As shown in FIG. 1, the discharge container 1 includes a discharge head 21 including a discharge port 21d from which bubbles are to be discharged, and a discharge head attachment 30 attached to the discharge head 21. Specifically, the discharge container 1 includes the container main body 10 in which liquid is contained, the dispenser 20 including the discharge head 21, and the discharge head attachment 30.

The container main body 10 is a hollow member including an opening at the upper end, and the dispenser 20 is attached to the opening. The liquid forming the bubbles to be discharged from the discharge container 1 is contained in the container main body 10.

As the liquid contained in the container main body 10, various liquids are applied and are not particularly limited. For example, liquid detergents such as a body wash, a hand wash, and a face wash, hair cosmetics (e.g., hairdressing, fixative, or hair tonic), skin cosmetics (e.g., skin lotion, emulsion, or serum), shaving foams, dishwashing detergents, or the like are applied. Further, the viscosity of the liquid is not particularly limited and is, for example, at 25° C., preferably 1 mPa·s or more, more preferably 2 mPa·s or more, and preferably 1000 mPa·s or less, more preferably 500 mPa·s or less, even more preferably 100 mPa·s or less. Note that the viscosity of the liquid can be measured, for example, using a B-type viscometer. Note that in the measurement conditions when the viscosity is measured, a rotor type, a rotation speed, and a rotation time that are determined on the basis of the viscosity level in each viscometer can be appropriately selected. The container main body 10 is formed of a resin, for example.

The dispenser 20 discharges the liquid contained in the container main body 10 as bubbles. The dispenser 20 is formed of a resin, for example.

Specifically, as shown in FIG. 1, the dispenser 20 includes the discharge head 21 and a cap 22. The cap 22 is screwed on the opening of the container main body 10, and thus the dispenser 20 is attached to the container main body 10. Additionally, the dispenser 20 also includes a pump mechanism (not shown) that mixes the liquid contained in the container main body 10 with air to generate bubbles and delivers the bubbles to the discharge head 21.

As the pump mechanism, known mechanisms can be widely applied. For example, the pump mechanism includes a liquid piston slidable inside a liquid cylinder in the vertical direction, an air piston slidable inside an air cylinder in the vertical direction, a stem disposed inside the opening of the container main body 10 and movable in the vertical direction in conjunction with the liquid piston and the air piston, and a spring for biasing the stem upwardly.

A mixing chamber 29 for mixing the liquid supplied from the liquid piston with the air supplied from the air cylinder is formed in a lower portion of the discharge head 21. When the discharge head 21 is pushed down, the liquid piston and the air piston are pushed down together with the stem, the liquid contained in the container main body 10 is supplied from the liquid piston to the mixing chamber 29, and air is supplied from the air cylinder to the mixing chamber 29. In such a manner, the liquid is mixed with the air in the mixing chamber 29, and bubbles are thus generated.

The discharge head 21 includes a first cylinder portion 21a inserted inside a tubular portion 22a protruding upwardly from the central side in the radial direction of the cap 22 and extending in the vertical direction, a second cylinder portion 21b covering the outer peripheral portion of the tubular portion 22a of the cap 22 and extending in the vertical direction, and a nozzle portion 21c extending in the radial direction of the first cylinder portion 21a from the upper portion of the first cylinder portion 21a.

The internal flow path of the first cylinder portion 21a communicates with the internal flow path of the nozzle portion 21c, and the discharge port 21d is formed at the tip of the nozzle portion 21c. Additionally, the above-mentioned mixing chamber 29 is formed in the lower portion of the internal flow path of the first cylinder portion 21a, and a first porous material 23 and a second porous material 24 are provided in this order from below on the downstream side (i.e., on the upper side) of the mixing chamber 29 in the internal flow path of the first cylinder portion 21a. Thus, the bubbles formed in the mixing chamber 29 are made fine after passing through the first porous material 23 and the second porous material 24 and then delivered to the internal flow path of the nozzle portion 21c through the internal flow path of the first cylinder portion 21a. The bubbles are then discharged from the discharge port 21d at the tip of the nozzle portion 21c.

Here, in the discharge container 1, the discharge head attachment 30 is attached to the discharge port 21d of the discharge head 21. Thus, the bubbles generated by the dispenser 20 pass through the discharge head 21 to be delivered from the discharge port 21d to the discharge head attachment 30, and are discharged to the outside of the discharge container 1 through the discharge head attachment 30.

The discharge head attachment 30 is a member for improving the visual appeal of the bubbles discharged from the discharge container 1. In the discharge container 1, since the bubbles generated by the dispenser 20 pass through the discharge head attachment 30 and flow out of the discharge container 1, the bubbles having a desired shape corresponding to the shape of the discharge head attachment 30 can be discharged. Further, in the discharge container 1, since the discharge head attachment 30 includes a porous portion to be described later, it is possible to improve the shape retention property of the bubbles. Therefore, it is possible to effectively improve the visual appeal of the bubbles discharged from the discharge container 1. Such a discharge head attachment 30 will be described in detail later.

<Discharge Head Attachment>

Next, the configuration of the discharge head attachment 30 according to the embodiment of the present invention will be described in detail with reference to FIGS. 1 to 7.

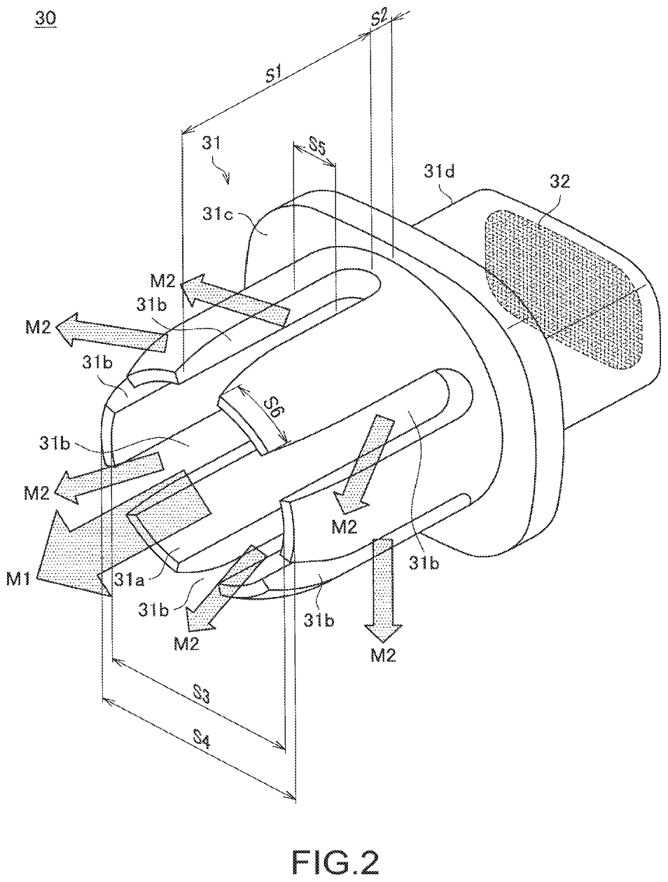

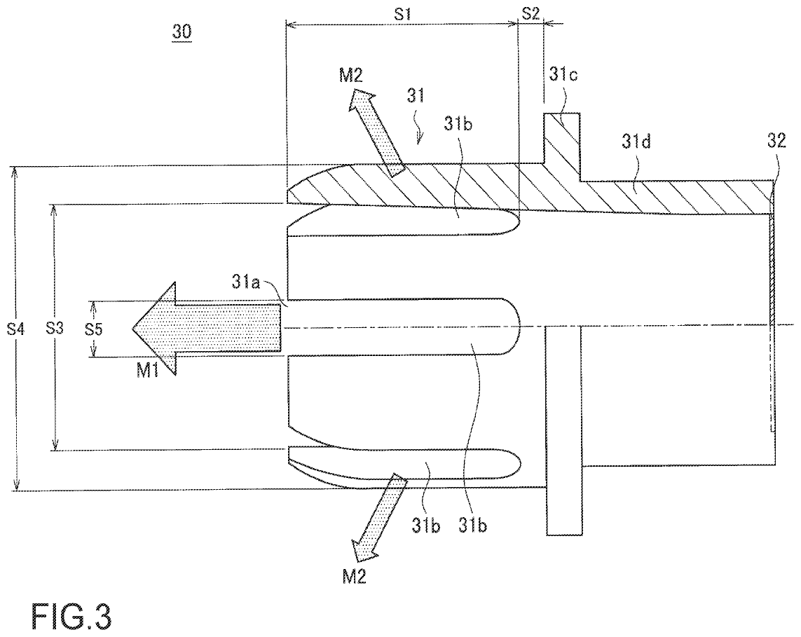

FIGS. 2 and 3 are a perspective view and a partial cross-sectional side view of the discharge head attachment 30, respectively.

As shown in FIGS. 1 to 3, the discharge head attachment 30 includes a cylindrical portion 31 connected to the discharge port 21d of the discharge head 21 on one side and including a first opening 31a on the other side, and a porous portion 32 provided on the one side of the cylindrical portion 31. Additionally, a second opening 31b is formed on the side portion of the cylindrical portion 31, and the peripheral edge of the first opening 31a extends at least partially along the circumferential direction of the cylindrical portion 31.

The discharge head attachment 30 is formed of, for example, a resin such as polyethylene, polypropylene, polyethylene terephthalate, or an ABS resin. Additionally, the discharge head attachment 30 is produced by, for example, injection molding. In such a case, the cylindrical portion 31 and the porous portion 32 are integrally formed.

The cylindrical portion 31 is a cylindrical portion having openings at both ends, and specifically has a substantially cylindrical shape.

A flange 31c protruding outwardly in the circumferential direction of the cylindrical portion 31 is formed on the central side in the axial direction of the cylindrical portion 31 in the cylindrical portion 31. A fitting portion 31d corresponding to a portion on the one side (i.e., the opposite side of the first opening 31a side) with respect to the flange 31c of the cylindrical portion 31 is inserted from the discharge port 21d of the discharge head 21 and fitted into the inner circumferential portion of the nozzle portion 21c. Thus, the cross-sectional shape of the fitting portion 31d is a shape corresponding to the cross-sectional shape of the nozzle portion 21c. The flange 31c abuts on the tip of the nozzle portion 21c, and thus the discharge head attachment 30 is positioned with respect to the discharge head 21. In such a manner, the discharge head attachment 30 is connectable to the discharge port 21d of the discharge head 21 on one side thereof.

In the discharge container 1, the discharge head attachment 30 is connected to the discharge port 21d of the discharge head 21 such that the axial direction of the cylindrical portion 31 is lateral or obliquely downward. In other words, it is preferable that the flow path of the discharge head attachment 30b is lateral or obliquely downward.

The second opening 31b is formed in the side portion on the other side (i.e., the first opening 31a side) with respect to the flange 31c of the cylindrical portion 31. Specifically, a plurality of second openings 31b are formed to be spaced apart from each other in the circumferential direction of the cylindrical portion 31, and are formed to extend in the axial direction of the cylindrical portion 31 so as to be continuous with the first opening 31a. Thus, as shown in FIGS. 2 and 3, the peripheral edge of the first opening 31a extends along the circumferential direction of the cylindrical portion 31 between the second openings 31b adjacent to each other. FIG. 2 shows an example in which six second openings 31b are disposed at equal intervals in the circumferential direction of the cylindrical portion 31.

The porous portion 32 is a film-like portion in which a plurality of through holes are formed, and is provided on the one side (i.e., on the opposite side of the first opening 31a side) of the cylindrical portion 31. More specifically, the porous portion 32 is provided at the tip portion of the cylindrical portion 31 on the one side. The bubbles delivered from the discharge head 21 to the discharge head attachment 30 become finer by passing through the porous portion 32. In such a manner, the porous portion 32 has a function of reducing the bubble diameter, which is the diameter of the bubble discharged from the discharge container 1.

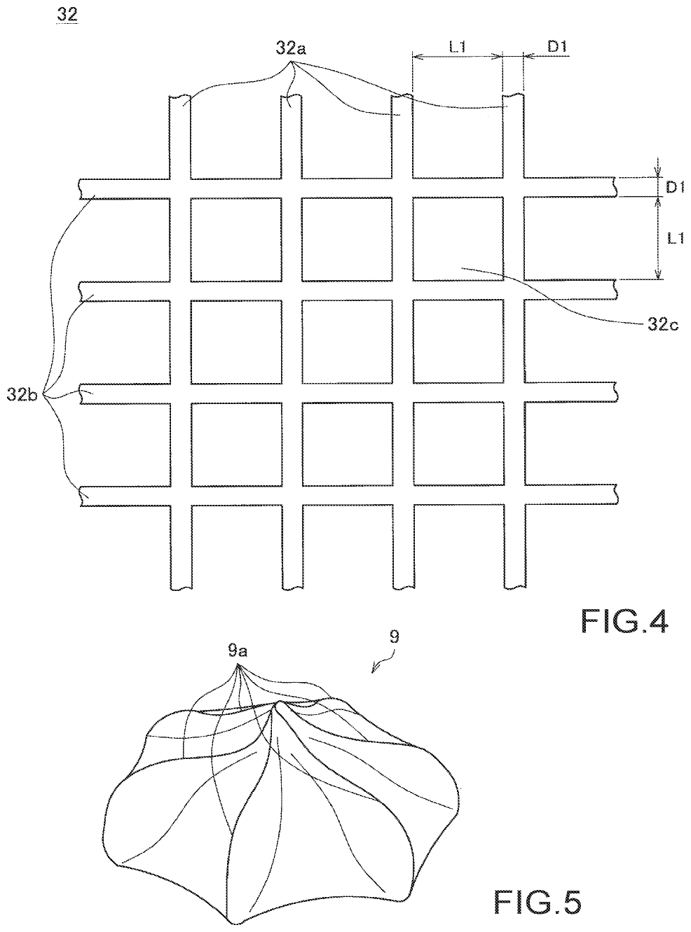

FIG. 4 is a diagram partially showing the porous portion 32.

Specifically, the porous portion 32 has a mesh shape as shown in FIG. 4. Specifically, the porous portion 32 includes a plurality of thread-like portions 32a extending in a first direction at intervals therebetween and a plurality of thread-like portions 32b extending in a second direction perpendicular to the first direction at intervals therebetween, and the plurality of thread-like portions 32a and the plurality of thread-like portions 32b define a plurality of pores 32c having a substantially rectangular shape. In the porous portion 32, the plurality of thread-like portions 32a and the plurality of thread-like portions 32b are arranged at equal intervals, and the interval between adjacent thread-like portions 32a and the interval between adjacent thread-like portions 32b substantially coincide with each other. Thus, each pore 32c has a substantially square shape of the same size.

Here, as shown in FIG. 4, a mesh opening L1 [μm] of the porous portion 32 corresponds to the length of one side of the pore 32c (i.e., the distance between adjacent thread-like portions). Additionally, a thread diameter D1 [μm] of the thread-like portion in the porous portion 32 is substantially the same among the thread-like portions, and a mesh opening ratio R1 [%] is expressed by the following equation (1).

$$\begin{matrix}[ Math . 1 ] & \\ R 1 = \frac{L {1}^{2}}{{( L 1 + D 1 )}^{2}} \times 100 & ( 1 )\end{matrix}$$

As described above, in the discharge container 1, the bubbles delivered from the discharge head 21 to the discharge head attachment 30 pass through the porous portion 32, and thus the bubble diameter of the bubble can be reduced. Here, the inventors of the present invention have found from the results of a test to be described later that the shape retention property of the bubbles can be improved by reducing the bubble diameter of the bubble discharged from the discharge container 1. Additionally, from the results of the above-mentioned test, the inventors of the present invention have obtained findings on the preferable dimension of the porous portion 32 from the viewpoint of more effectively improving the shape retention property of the bubbles discharged from the discharge container 1.

Specifically, from the viewpoint of more effectively improving the shape retention property of the bubbles discharged from the discharge container 1, it has been found that the mesh opening L1 of the porous portion 32 is preferably smaller than a mean bubble diameter of the bubbles delivered from the discharge head 21 to the discharge head attachment 30.

Additionally, from the viewpoint of more effectively improving the shape retention property of the bubbles discharged from the discharge container 1, it has been found that the mesh opening ratio R1 of the porous portion 32 is preferably larger than 10%. Here, it is preferable that the mesh opening ratio R1 of the porous portion 32 is equal to or smaller than the mesh opening ratio of the porous material (specifically, the first porous material 23 and the second porous material 24) provided in the internal flow path of the discharge head 21.

Nylon, polyester, or the like can be preferably used as the material of the porous portion 32.

As described above, the second openings 31b are formed in the side potion of the cylindrical portion 31 of the discharge head attachment 30 attached to the discharge head 21 of the discharge container 1. Additionally, the peripheral edge of the first opening 31a extends at least partially along the circumferential direction of the cylindrical portion 31. Thus, the bubbles delivered from the discharge head 21 to the discharge head attachment 30 can be discharged from the first opening 31a in the axial direction of the cylindrical portion 31 and also discharged outwardly in the radial direction of the cylindrical portion 31 through each second opening 31b. In FIGS. 2 and 3, the flow of the bubbles discharged from the first opening 31a is indicated by an arrow M1, and the flow of the bubbles discharged from each second opening 31b is indicated by an arrow M2. In this manner, the flow of the bubbles passing through the first opening 31a, which is indicated by the arrow M1, and the flow of the bubbles passing through each second opening 31b, which is indicated by the arrow M2, are formed, thus allowing the bubbles having a desired shape to be discharged.

From the viewpoints described above, a ratio S3/S1 of an inner diameter S3 of the cylindrical portion 31 to a length S1 in the axial direction of the cylindrical portion 31 in the second opening 31b is preferably 0.3 or more, more preferably 0.5 or more, and also preferably 3.5 or less, more preferably 3.0 or less. This is because, when the ratio S3/S1 is set to a value within an appropriate range that is not excessively small and not excessively large, the flow of the bubbles passing through each second opening 31b is appropriately formed, and edges (for example, edges 9a of a foam 9 in FIG. 5, which will be described later) are easily formed in a foam formed using the discharge head attachment 30, thus making it easier to obtain a desired shape as the shape of the bubbles to be discharged. Note that when the shape of the first opening 31a is other than a circular shape, for example, the diameter of a circle having the same area as the opening area of the first opening 31a can be used as the value of the inner diameter S3 of the cylindrical portion 31. Additionally, the length S1 in the axial direction of the cylindrical portion 31 in the second opening 31b is preferably longer than a length S6 of the peripheral edge of the first opening 31a extending between the second openings 31b adjacent to each other. Additionally, the length S1 in the axial direction of the cylindrical portion 31 in the second opening 31b is preferably longer than a length S5 in the circumferential direction of the cylindrical portion 31 in the second opening 31b.

FIG. 5 is a schematic view of the foam 9 formed using the discharge head attachment 30.

The foam 9 is an object formed of bubbles, which is formed on a bubble receiver (e.g., a palm of a hand), on which the bubbles are received, by discharging the bubbles from the discharge container 1 to the bubble receiver. As shown in FIG. 5, the six edges 9a are formed radially from the center outwardly in the foam 9 formed using the discharge head attachment 30. Those edges 9a are formed in the foam 9 by forming the flow of bubbles passing through the respective second openings 31b of the discharge head attachment 30 when the bubbles are discharged from the discharge container 1. In such a manner, a desired shape can be obtained as the shape of the foam 9 by using the above-mentioned discharge head attachment 30.

From the viewpoint of ensuring the strength on the first opening 31a side with respect to the flange 31c in the cylindrical portion 31 and also easily obtaining a desired shape as the shape of the bubbles to be discharged, the length S5 in the circumferential direction of the cylindrical portion 31 in the second opening 31b is preferably 1 mm or more, more preferably 1.2 mm or more, and preferably 2 mm or less, more preferably 1.8 mm or less. This is because a desired shape can be easily obtained as the shape of the bubbles to be discharged when the length S5 is set to a certain value or more, and the strength on the first opening 31a side with respect to the flange 31c in the cylindrical portion 31 decreases when the length S5 is excessively long.

From the viewpoint of ensuring the strength on the first opening 31a side with respect to the flange 31c in the cylindrical portion 31 and also easily obtaining a desired shape as the shape of the bubbles to be discharged, the length S1 in the axial direction of the cylindrical portion 31 in the second opening 31b is preferably 4 mm or more, more preferably 5 mm or more, and preferably 8 mm or less, more preferably 7 mm or less. This is because a desired shape can be easily obtained as the shape of the bubbles to be discharged when the length S1 is set to a certain value or more, and the strength on the first opening 31a side with respect to the flange 31c in the cylindrical portion 31 decreases when the length S1 is excessively long.

From the viewpoint of easily obtaining a desired shape as the shape of the bubbles to be discharged, an interval S2 in the axial direction of the cylindrical portion 31 between the second opening 31b and the flange 31c is preferably 0.5 mm or more, more preferably 1 mm or more. This is because the bubbles that have passed through each second opening 31b can be suppressed from coming into contact with the flange 31c when the interval S2 is set to a certain value or more, and thus the edges 9a formed in the foam 9 can be suppressed from being thicker than those of a desired shape.

From the viewpoint of easily obtaining a desired shape as the shape of the bubbles to be discharged, an outer diameter S4 on the first opening 31a side with respect to the flange 31c in the cylindrical portion 31 is preferably 5 mm or more, more preferably 7 mm or more, and also more preferably 15 mm or less, more preferably 10 mm or less. This is because a desired shape can be easily obtained as the shape of the bubbles to be discharged when the outer diameter S4 is set to a dimension within an appropriate range that is not excessively small and not excessively large.

From the viewpoint of easily obtaining a desired shape as the shape of the bubbles to be discharged, an inner diameter S3 of the cylindrical portion 31 is preferably 4 mm or more, more preferably 5 mm or more, and also more preferably 13 mm or less, more preferably 10 mm or less. This is because a desired shape can be easily obtained as the shape of the bubbles to be discharged when the inner diameter S3 is set to a dimension within an appropriate range that is not excessively small and not excessively large.

Additionally, as described above, the discharge container 1 includes the porous portion 32 on one side of the cylindrical portion 31 of the discharge head attachment 30. This allows the bubbles delivered from the discharge head 21 to the discharge head attachment 30 to be discharged to the outside of the discharge container 1 after passing through the porous portion 32. Thus, the bubble diameter of the bubble discharged from the discharge container 1 can be reduced. This allows an improvement in the shape retention property of the bubbles discharged from the discharge container 1. Thus, it is possible to effectively improve the visual appeal of the bubbles discharged from the discharge container 1.

Here, the pressure for the bubbles to be delivered from the discharge head 21 to the discharge head attachment 30 increases as the bubbles pass through the porous portion 32. Thus, providing the porous portion 32 in the discharge head attachment 30 allows an increase in the momentum of the flow of the bubbles discharged outwardly in the radial direction of the cylindrical portion 31 through the second openings 31b, as compared with the case where no porous portion 32 is provided. This makes it easier to obtain a desired shape as the shape of the bubbles to be discharged from the discharge container 1.

In the above description, the discharge head attachment 30 has been described as the discharge head attachment to be attached to the discharge head 21 of the discharge container 1, but the shape of the discharge head attachment to be attached to the discharge head 21 is not particularly limited to the shape of the example described above. Hereinafter, a discharge head attachment 130 according to another embodiment, which is different from the discharge head attachment 30 shown in FIGS. 2 and 3 described above, will be described as another example of the discharge head attachment to be attached to the discharge head 21.

The discharge head attachment 130 differs from the discharge head attachment 30 described above mainly in the shape and number of the second opening formed in the cylindrical portion.

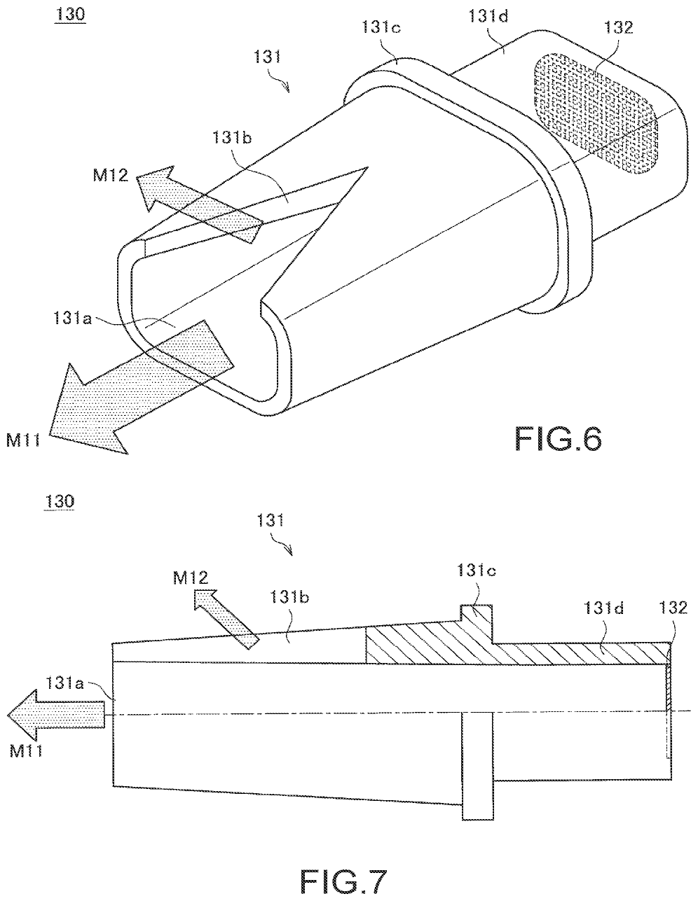

FIGS. 6 and 7 are a perspective view and a partial cross-sectional side view of the discharge head attachment 130, respectively.

As shown in FIGS. 6 and 7, the discharge head attachment 130 includes a cylindrical portion 131 and a porous portion 132. Similar to the discharge head attachment 30 described above, the cylindrical portion 131 is connected to the discharge port 21d of the discharge head 21 on one side and includes a first opening 131a on the other side. Additionally, the porous portion 132 is a film-like portion in which a plurality of through holes are formed, and is provided on one side (i.e., on the opposite side of the first opening 131a side) of the cylindrical portion 131. Additionally, the discharge head attachment 130 is produced by, for example, injection molding.

A flange 131c protruding outwardly in the circumferential direction of the cylindrical portion 131 is formed on the central side in the axially direction of the cylindrical portion 131 in the cylindrical portion 131. A fitting portion 131d on the one side (i.e., the opposite side of the first opening 131a side) with respect to the flange 131c of the cylindrical portion 131 is inserted from the discharge port 21d of the discharge head 21 and fitted into the inner circumferential portion of the nozzle portion 21c. The flange 131c abuts on the tip of the nozzle portion 21c, and thus the discharge head attachment 130 is positioned with respect to the discharge head 21.

Here, a substantially V-shaped second opening 131b is formed in the side portion on the other side (i.e., the first opening 131a side) with respect to the flange 131c in the cylindrical portion 131 so as to be continuous with the first opening 131a. Specifically, the width in the circumferential direction of the cylindrical portion 131 in the second opening 131b decreases toward the one side (i.e., the opposite side of the first opening 131a side). The peripheral edge of the first opening 131a extends along the circumferential direction of the cylindrical portion 131 except a portion connected to the second opening 131b. Note that the porous portion 132 is provided on the one side (i.e., on the opposite side of the first opening 131a side) with respect to the second opening 131b in the cylindrical portion 131.

As described above, in the discharge head attachment 130 as well, the second opening 131b is formed in the side portion of the cylindrical portion 131 in the same manner as in the discharge head attachment 30 described above. Additionally, the peripheral edge of the first opening 131a extends at least partially along the circumferential direction of the cylindrical portion 131. Thus, the bubbles delivered from the discharge head 21 to the discharge head attachment 130 can be discharged from the first opening 131a in the axial direction of the cylindrical portion 131 and also discharged outwardly in the radial direction of the cylindrical portion 131 through the second opening 131b. In FIGS. 6 and 7, the flow of the bubbles discharged from the first opening 131a is indicated by an arrow M11, and the flow of the bubbles discharged from the second opening 131b is indicated by an arrow M12. In this manner, the flow of the bubbles passing through the first opening 131a, which is indicated by the arrow M11, and the flow of the bubbles passing through the second opening 131b, which is indicated by the arrow M12, are formed, thus allowing the bubbles having a desired shape to be discharged.

Additionally, as described above, in the discharge head attachment 130 as well, the porous portion 132 is provided on the one side of the cylindrical portion 131 in the same manner as in the discharge head attachment 30 described above. This allows the bubbles delivered from the discharge head 21 to the discharge head attachment 130 to be discharged to the outside of the discharge container 1 after passing through the porous portion 132. Thus, the bubble diameter of the bubble discharged from the discharge container 1 can be reduced. This allows an improvement in the shape retention property of the bubbles discharged from the discharge container 1. Thus, it is possible to effectively improve the visual appeal of the bubbles discharged from the discharge container 1.

As described above, the configuration of the discharge head attachment to be attached to the discharge head 21 of the discharge container 1 is not particularly limited. For example, as shown in FIGS. 2 and 3, the shape of the portion on the other side (i.e., the first opening 31a side) with respect to the flange 31c in the discharge head attachment 30 is a substantially cylindrical shape, whereas as shown in FIGS. 6 and 7, the shape of the portion on the other side (i.e., the first opening 131a side) with respect to the flange 131c in the discharge head attachment 130 is a substantially rounded square cylindrical shape.

Here, from the viewpoint of suppressing an increase in manufacturing cost of the discharge head attachment 30, 130, as shown in FIGS. 3 and 7, it is preferable that the inner diameter of the cylindrical portion 31, 131 becomes smaller toward the porous portion 32, 132 on the first opening 31a, 131a side than the porous portion 32, 132. As a result, when the discharge head attachment 30, 130 is manufactured by injection molding, the mold located on the other side (i.e., on the first opening 31a, 131a side) with respect to the porous portion 32, 132 in the cylindrical portion 31, 131 can be easily pulled out from the inside of the cylindrical portion 31, 131. Thus, it is possible to suppress an increase in manufacturing cost of the discharge head attachment 30, 130.

### EXAMPLES

Hereinafter, the results of a test performed to confirm the relationship between the shape retention property of the bubbles discharged from the discharge container 1 and the dimension of the porous portion 32 will be described.

In this test, bubbles were discharged using the discharge container 1 including the above-mentioned discharge head attachment 30 under conditions of various different dimensions of the porous portion 32, and a mean bubble diameter at the time of discharge and the shape retention property of the discharged bubbles were evaluated for each of the conditions. The mean bubble diameter at the time of discharge is a mean value of the bubble diameters of the bubbles after passing through the porous portion 32 of the discharge head attachment 30. Further, in this test, a pushing force, which is an index indicating the degree of the force for pushing down the discharge head 21, was evaluated for each of the conditions.

Specifically, in this test, bubbles were discharged from the discharge container 1 into a glass cylinder, and the mean bubble diameter at a time point of the elapse of approximately 1 second after the time point of the discharge of the bubbles was measured by using a bubble diameter measuring apparatus. Note that, schematically, an apparatus for obtaining various types of information such as the bubble diameter by performing image processing on a captured image of the bubbles was used as the bubble diameter measuring apparatus.

Additionally, in this test, bubbles were discharged to the palm of the hand approximately 1 cm to 2 cm away from the discharge container 1, and the foam formed on the palm was visually observed, thus evaluating the shape retention property of the bubbles discharged from the discharge container 1. Note that the bubbles were discharged with the palm being substantially orthogonal to the discharge direction of the bubbles.

Additionally, in this test, the maximal stress when the discharge head 21 was pushed down to the bottom dead center at a rate of approximately 30 mm/s was measured as the pushing force by using a stress measuring apparatus. Note that, as the stress measuring apparatus, an apparatus for measuring the stress generated in the discharge head 21 by detecting the force applied to the discharge head 21 using a load cell was used.

Additionally, in this test, among the values relating to the dimensions of the porous portion 32, the mesh opening L1 of the porous portion 32, the thread diameter D1 of the thread-like portion in the porous portion 32, the mesh opening ratio R1 of the porous portion 32, and the thickness of the porous portion 32 were variously differentiated as the test conditions. In addition, the viscosity of the liquid contained in the container main body 10 was variously differentiated as another test condition. Note that a mesh-like porous material having the same size was used as the first porous material 23 and the second porous material 24 in the discharge head 21 of the dispenser 20, and in this porous material, the mesh opening was 77 μm, the thread diameter of the thread-like portion was 50 μm, the mesh opening ratio was 37%, and the thickness was 83 μm. As described above, the mesh opening ratio R1 of the porous portion 32 is preferably equal to or smaller than the mesh opening ratio of the porous material (37% in this test).

The results of this test are shown in Tables 1 to 3. Tables 1, 2, and 3 show the results when liquids having viscosities of 8.5 mPa·s, 5.8 mPa·s, and 2.0 mPa·s are used as the liquids contained in the container main body 10, respectively. Note that in the following description, the evaluation results of the shape retention property of the bubbles are represented by the symbols “cross”, “triangle”, “circle”, and “double circle”, which indicate that the shape retention property of the bubbles increases (that is, improves) in the order of “cross”, “triangle”, “circle”, and “double circle”.

TABLE 1
Viscosity of liquid: 8.5 mPa · s

| Conditions | 1 | 2 | 3 | 4 | 5 |
|---|---|---|---|---|---|
| Mesh opening L1[μm] | 177 | 77 | 48 | 21 | 11 |
| Thread diameter D1[μm] | 105 | 50 | 35 | 30 | 36 |
| Mesh opening ratio R1 of | 39 | 37 | 34 | 17 | 6 |
| porous portion[%] | | | | | |
| Thickness[μm] | 185 | 83 | 60 | 65 | 65 |
| Mesh opening ratio of | 37 | 37 | 37 | 37 | 37 |
| porous material[%] | | | | | |
| Pushing force[N] | 29.5 | 34 | 35 | 45 | 51 |
| Mean bubble diameter at | 108 | 99 | 95 | 86 | 99 |
| discharge[μm] | | | | | |
| Shape retention property | ◯ | ⊚ | ⊚ | ⊚ | Δ |

TABLE 2
Viscosity of liquid: 5.8 mPa · s

| Conditions | 6 | 7 | 8 | 9 | 10 |
|---|---|---|---|---|---|
| Mesh opening L1[μm] | 177 | 77 | 48 | 21 | 11 |
| Thread diameter D1[μm] | 105 | 50 | 35 | 30 | 36 |
| Mesh opening ratio R1 of | 39 | 37 | 34 | 17 | 6 |
| porous portion[%] | | | | | |
| Thickness[μm] | 185 | 83 | 60 | 65 | 65 |
| Mesh opening ratio of | 37 | 37 | 37 | 37 | 37 |
| porous material[%] | | | | | |
| Pushing force[N] | 27.2 | 30.8 | 32.9 | 34.8 | 42.3 |
| Mean bubble diameter at | 120 | 101 | 99 | 88 | 97 |
| discharge[μm] | | | | | |
| Shape retention property | Δ | ⊚ | ⊚ | ⊚ | ◯ |

TABLE 3
Viscosity of liquid: 2.0 mPa · s

| Conditions | 11 | 12 | 13 | 14 | 15 |
|---|---|---|---|---|---|
| Mesh opening L1[μm] | 177 | 77 | 48 | 21 | 11 |
| Thread diameter D1[μm] | 105 | 50 | 35 | 30 | 36 |
| Mesh opening ratio R1 of | 39 | 37 | 34 | 17 | 6 |
| porous portion[%] | | | | | |
| Thickness[μm] | 185 | 83 | 60 | 65 | 65 |
| Mesh opening ratio of | 37 | 37 | 37 | 37 | 37 |
| porous material[%] | | | | | |
| Pushing force[N] | 25.2 | 27.7 | 28.9 | 32.9 | 37.8 |
| Mean bubble diameter at | 150 | 122 | 110 | 89 | 77 |
| discharge[μm] | | | | | |
| Shape retention property | Δ | ⊚ | ⊚ | ⊚ | ◯ |

Here, separately from the above test, the mean bubble diameter of the bubbles delivered from the discharge head 21 to the discharge head attachment 30 was investigated. Specifically, the mean bubble diameter at the time of discharge was measured with a discharge head attachment being attached to the discharge head 21, the discharge head attachment having the configuration of the discharge head attachment 30 but omitting the porous portion 32. As a result, it was found that the mean bubble diameter of the bubbles delivered from the discharge head 21 to the discharge head attachment 30 was approximately 105 μm, approximately 125 μm, and approximately 153 μm when the viscosity of the liquid contained in the container main body 10 was 8.5 mPa·s, 5.8 mPa·s, and 2.0 mPa·s, respectively.

Referring to Table 1 (test results when the viscosity of the liquid is 8.5 mPa·s), it can be found that, as compared with Condition 1 in which the mesh opening L1 of the porous portion 32 is larger than the mean bubble diameter (approximately 105 μm) of the bubbles delivered from the discharge head 21 to the discharge head attachment 30, Conditions 2 to 4 in which the mesh opening L1 is smaller than the mean bubble diameter have further improved shape retention property. Further, referring to Table 1, it can be found that, as compared with Condition 5 in which the mesh opening ratio L1 is smaller than the above-mentioned mean bubble diameter but the mesh opening ratio R1 of the porous portion 32 is smaller than 10%, Conditions 2 to 4 in which the mesh opening ratio R1 of the porous portion 32 is larger than 10% have further improved shape retention property.

Additionally, referring to Table 2 (test results when the viscosity of the liquid is 5.8 mPa·s), it can be found that, as compared with Condition 6 in which the mesh opening L1 of the porous portion 32 is larger than the mean bubble diameter (approximately 125 μm) of the bubbles delivered from the discharge head 21 to the discharge head attachment 30, Conditions 7 to 9 in which the mesh opening L1 is smaller than the mean bubble diameter have further improved shape retention property. Further, referring to Table 2, it can be found that, as compared with Condition 10 in which the opening ratio L1 is smaller than the mean bubble diameter but the mesh opening ratio R1 of the porous portion 32 is smaller than 10°, Conditions 7 to 9 in which the mesh opening ratio R1 of the porous portion 32 is larger than 10% have further improved shape retention property.

Additionally, referring to Table 3 (test results when the viscosity of the liquid is 2.0 mPa·s), it can be found that, as compared with Condition 11 in which the mesh opening L1 of the porous portion 32 is larger than the mean bubble diameter (approximately 153 μm) of the bubbles delivered from the discharge head 21 to the discharge head attachment 30, Conditions 12 to 14 in which the mesh opening L1 is smaller than the mean bubble diameter have further improved shape retention property. Further, referring to Table 3, it can be found that, as compared with Condition 15 in which the mesh opening ratio L1 is smaller than the above-mentioned mean bubble diameter but the mesh opening ratio R1 of the porous portion 32 is smaller than 10%, Conditions 12 to 14 in which the mesh opening ratio R1 of the porous portion 32 is larger than 10% have further improved shape retention property.

From the above results, it is found that the shape retention property of the bubbles discharged from the discharge container 1 can be more effectively improved by making the mesh opening L1 of the porous portion 32 smaller than the mean bubble diameter of the bubbles delivered from the discharge head 21 to the discharge head attachment 30. It is conceivable that this results from the fact that the mean bubble diameter at the time of discharge can be effectively reduced as shown in Tables 1 to 3 by making the mesh opening L1 smaller than the mean bubble diameter of the bubbles delivered from the discharge head 21 to the discharge head attachment 30. Specifically, it is conceivable that, when the mean bubble diameter at the time of discharge is reduced, the resilience and viscosity of the bubbles are increased, thus improving the shape retention property of the bubbles.

Note that even if the mesh opening L1 is equal to or larger than the mean bubble diameter of the bubbles delivered to the discharge head attachment 30, coarse bubbles included in the bubbles delivered to the discharge head attachment 30 can be made small. Thus, even if the mean bubble diameter does not change significantly before and after the bubbles pass through the porous portion 32, the shape retention property of the bubbles can be improved.

Additionally, from the above results, it is found that the shape retention property of the bubbles discharged from the discharge container 1 can be more effectively improved by making the mesh opening ratio R1 of the porous portion 32 larger than 10%. Here, it is conceivable that the pressure applied to the bubbles passing through the porous portion 32 increases as the mesh opening ratio R1 decreases, and thus the bubble breakage or coalescence of the bubbles tends to occur after the bubbles pass though the porous portion 32. Thus, it is conceivable that when the mesh opening ratio R1 is made larger than 10%, the bubble breakage and coalescence of the bubbles are suppressed from occurring, and as a result of suppressing coarse pores from being generated, the shape retention property of the bubbles can be more effectively improved.

Note that the pressure applied to the bubbles passing through the porous portion 32 decreases as the mesh opening ratio R1 increases, and thus the pushing force can be made smaller as the mesh opening ratio R1 increases as shown in Tables 1 to 3. Thus, it is preferable to set the mesh opening ratio R1 so as to decrease the pushing force to the extent that the operability of the discharge container 1 can be improved.

Additionally, separately from the above test, as a comparative example, using a discharge container including a discharge head attachment attached to the discharge head 21, the discharge head attachment having the configuration of the discharge head attachment 30 but omitting the porous portion 32, bubbles were discharged and the shape retention property of the discharged bubbles was evaluated by the method similar to the above method. As a result, the result of evaluating the shape retention property of the bubbles discharged by the above-mentioned discharge container in which the discharge head attachment includes no porous portion 32 was “cross”. Thus, it was confirmed that providing the porous portion 32 in the discharge head attachment allows an improvement in the shape retention property of the bubbles.

While the suitable embodiments of the present invention have been described in detail with reference to the accompanying drawings, the present invention is not limited to such examples. It is obvious that various modifications or applications can be conceived by those skilled in the art to which the present invention belongs within the scope of the technical idea described in the claims, and it is understood that those modifications and applications belong to the technical scope of the present invention as a matter of course.

For example, the example has been described above in which the second opening 31b, 131b formed in the side portion of the cylindrical portion 131 of the discharge head attachment 30, 130 is continuous with the first opening 31a, 131a, but the second opening according to the present invention need not be continuous with the first opening. In other words, the second opening need not extend to the peripheral edge of the first opening and not be connected to the peripheral edge.

Additionally, for example, the shape and the number of second openings in the discharge head attachment according to the present invention are not particularly limited, and may be different from the shape and the number of second openings in the discharge head attachment 30, 130 described above. For example, the tip of the portion between the second openings 31b adjacent to each other in the discharge head attachment 30 (i.e., the portion protruding from the flange 31c to the first opening 31a side) may have a rounded shape (e.g., a spherical shape). As a result, it is possible to improve safety in the case where the user's hand touches the above-mentioned portion between the second openings 31b adjacent to each other.

Additionally, for example, the example has been mainly described above in which the discharge head attachment 30, 130 is produced by injection molding, but the discharge head attachment according to the present invention may be produced by other processing methods. Additionally, the cylindrical portion 31, 131 and the porous portion 32, 132 may be formed as separate members. Further, the cylindrical portion 31, 131 may include a plurality of members, and the porous portion 32, 132 may include a plurality of members. Additionally, in the discharge head attachment 30, 130, the portion on the first opening 31a, 131a side and the portion on the porous portion 32, 132 side may be formed as separate members. For example, the discharge head attachment 30, 130 may include two members, a member on the first opening 31a, 131a side and a member on the porous portion 32, 132 side.

Additionally, for example, the discharge head attachment 30, 130 may further include a cover for covering the first opening 31a, 131a. Thus, for example, it is possible to suppress the user's hand from touching the portion between the second openings 31b adjacent to each other in the discharge head attachment 30 (i.e., the portion protruding from the flange 31c to the first opening 31a side), and thus it is possible to improve the safety and further suppress the portion between the second openings 31b adjacent to each other from being damaged (e.g., bent).

Additionally, for example, the example has been described above in which the two porous materials (specifically, the first porous material 23 and the second porous material 24) are provided in the dispenser 20, but the number of porous materials provided in the dispenser 20 is not particularly limited to the above example. For example, three porous materials may be provided in the dispenser 20.

Additionally, regarding the embodiments described above, the present invention further discloses the following discharge container and discharge head attachment.

<1> A discharge container, comprising:

a discharge head including a discharge port from which bubbles are to be discharged; and

a discharge head attachment attached to the discharge head, wherein

the discharge head attachment includes
a cylindrical portion connected to the discharge port on one side and including a first opening on another side, and
a porous portion provided on the one side of the cylindrical portion,

a side portion of the cylindrical portion includes a second opening, and

a peripheral edge of the first opening extends at least partially along a circumferential direction of the cylindrical portion.

<2> The discharge container according to <1>, wherein

a mesh opening of the porous portion is smaller than a mean bubble diameter of the bubbles delivered from the discharge head to the discharge head attachment.

<3> The discharge container according to <1> or <2>, wherein

a mesh opening ratio of the porous portion is larger than 10%.

<4> The discharge container according to any one of <1> to <3>, wherein

an inner diameter of the cylindrical portion becomes smaller toward the porous portion on the first opening side than the porous portion.

<5> The discharge container according to any one of <1> to <4>, comprising:

a container main body that contains liquid; and

a dispenser including the discharge head, wherein

the dispenser includes a pump mechanism that mixes the liquid contained in the container main body with air to generate bubbles and sends the bubbles to the discharge head.

<6> The discharge container according to <5>, further comprising

the liquid contained in the container main body.

<7> The discharge container according to <5> or <6>, wherein

a viscosity of the liquid contained in the container main body is preferably 1 mPa·s or more, more preferably 2 mPa·s or more, and preferably 1000 mPa·s or less, more preferably 500 mPa·s or less, even more preferably 100 mPa·s or less, at 25° C.

<8> The discharge container according to any one of <1> to <7>, wherein

an internal flow path of the discharge head includes a porous material.

<9> The discharge container according to <8>, wherein

a plurality of the porous materials are provided.

<10> The discharge container according to <8> or <9>, wherein

the mesh opening ratio of the porous portion is equal to or smaller than a mesh opening ratio of the porous material.

<11> The discharge container according to any one of <1> to <10>, wherein

a flange protruding outwardly in the circumferential direction of the cylindrical portion is formed on the central side of the cylindrical portion in an axial direction.

<12> The discharge container according to any one of <1> to <11>, wherein

a plurality of the second openings are formed at intervals in the circumferential direction of the cylindrical portion.

<13> The discharge container according to <12>, wherein

the peripheral edge of the first opening extends along the circumferential direction of the cylindrical portion between the second openings adjacent to each other.

<14> The discharge container according to <12> or <13>, wherein

a length in the axial direction of the cylindrical portion in the second opening is longer than a length of the peripheral edge of the first opening extending between the second openings adjacent to each other.

<15> The discharge container according to any one of <1> to <14>, wherein

the second opening is formed extending in the axial direction of the cylindrical portion continuously with the first opening.

<16> The discharge container according to any one of <1> to <15>, wherein

a ratio of the inner diameter of the cylindrical portion to the length in the axial direction of the cylindrical portion in the second opening is preferably 0.3 or more, more preferably 0.5 or more, and preferably 3.5 or less, more preferably 3.0 or less.

<17> The discharge container according to any one of <1> to <16>, wherein

the length in the axial direction of the cylindrical portion in the second opening is longer than the length in the circumferential direction of the cylindrical portion in the second opening.

<18> The discharge container according to any one of <1> to <17>, wherein

a width in the circumferential direction of the cylindrical portion in the second opening decreases toward the one side.

<19> The discharge container according to any one of <1> to <18>, wherein

the porous portion has a mesh shape.

<20> The discharge container according to any one of <1> to <19>, wherein

the discharge head attachment is connected to the discharge port such that the axial direction of the cylindrical portion is lateral or obliquely downward.

<21>A discharge head attachment attached to a discharge head including a discharge port from which bubbles are to be discharged, the discharge head attachment comprising:

a cylindrical portion connectable to the discharge port on one side and including a first opening on another side; and

a porous portion provided on the one side of the cylindrical portion, wherein

a side portion of the cylindrical portion includes a second opening, and

a peripheral edge of the first opening extends at least partially along a circumferential direction of the cylindrical portion.

<22> The discharge head attachment according to <21>, wherein

a mesh opening of the porous portion is smaller than a mean bubble diameter of the bubbles delivered from the discharge head to the discharge head attachment.

<23> The discharge head attachment according to <21> or <22>, wherein

a mesh opening ratio of the porous portion is larger than 10%.

<24> The discharge head attachment according to any one of <21> to <23>, wherein

an inner diameter of the cylindrical portion becomes smaller toward the porous portion on the first opening side than the porous portion.

<25> The discharge head attachment according to any one of <21> to <24>, wherein

a flange protruding outwardly in the circumferential direction of the cylindrical portion is formed on the central side of the cylindrical portion in an axial direction.

<26> The discharge head attachment according to any one of <21> to <25>, wherein

a plurality of the second openings are formed at intervals in the circumferential direction of the cylindrical portion.

<27> The discharge head attachment according to <26>, wherein

the peripheral edge of the first opening extends along the circumferential direction of the cylindrical portion between the second openings adjacent to each other.

<28> The discharge head attachment according to <26> or <27>, wherein

a length in the axial direction of the cylindrical portion in the second opening is longer than a length of the peripheral edge of the first opening extending between the second openings adjacent to each other.

<29> The discharge head attachment according to any one of <21> to <28>, wherein

the second opening is formed extending in the axial direction of the cylindrical portion continuously with the first opening.

<30> The discharge head attachment according to any one of <21> to <29>, wherein

a ratio of the inner diameter of the cylindrical portion to the length in the axial direction of the cylindrical portion in the second opening is preferably 0.3 or more, more preferably 0.5 or more, and preferably 3.5 or less, more preferably 3.0 or less.

<31> The discharge head attachment according to any one of <21> to <30>, wherein

the length in the axial direction of the cylindrical portion in the second opening is longer than the length in the circumferential direction of the cylindrical portion in the second opening.

<32> The discharge head attachment according to any one of <21> to <31>, wherein

a width in the circumferential direction of the cylindrical portion in the second opening decreases toward the one side.

<33> The discharge head attachment according to any one of <21> to <32>, wherein

the porous portion has a mesh shape.

### REFERENCE SIGNS LIST

1 discharge container
9 foam
9a edge
10 container main body
20 dispenser
21 discharge head
21a first cylinder portion
21b second cylinder portion
21c nozzle portion
21d discharge port
22 cap
22a tubular portion
23 first porous material
24 second porous material
29 mixing chamber
30, 130 discharge head attachment
31, 131 cylindrical portion
31a, 131a first opening
31b, 131b second opening
31c, 131c flange
31d, 131d fitting portion
32, 132 porous portion
32a, 32b thread-like portion
32c pore

1. A discharge container, comprising:
a discharge head including a discharge port from which bubbles are to be discharged; and
a discharge head attachment attached to the discharge head, wherein
the discharge head attachment includes
a cylindrical portion connected to the discharge port on one side and including a first opening on another side, and
a porous portion provided on the one side of the cylindrical portion,
a side portion of the cylindrical portion includes a second opening, and
a peripheral edge of the first opening extends at least partially along a circumferential direction of the cylindrical portion.

2. The discharge container according to claim 1, wherein
a mesh opening of the porous portion is smaller than a mean bubble diameter of the bubbles delivered from the discharge head to the discharge head attachment.

3. The discharge container according to claim 1, wherein
a mesh opening ratio of the porous portion is larger than 10%.

4. (canceled)

5. The discharge container according to claim 1, further comprising:
a container main body that contains liquid; and
a dispenser including the discharge head, wherein
the dispenser includes a pump mechanism that mixes the liquid contained in the container main body with air to generate bubbles and sends the bubbles to the discharge head.

6. (canceled)

7. The discharge container according to claim 5, wherein
a viscosity of the liquid contained in the container main body is 1 mPa·s or more and 1000 mPa·s or less at 25° C.

8. The discharge container according to claim 1, wherein
an internal flow path of the discharge head includes a porous material.

9. (canceled)

10. The discharge container according to claim 8, wherein
the mesh opening ratio of the porous portion is equal to or smaller than a mesh opening ratio of the porous material.

11. The discharge container according to claim 1, wherein
a flange protruding outwardly in the circumferential direction of the cylindrical portion is formed on the central side of the cylindrical portion in an axial direction.

12. The discharge container according to claim 1, wherein
a plurality of the second openings are formed at intervals in the circumferential direction of the cylindrical portion.

13. (canceled)

14. The discharge container according to claim 12, wherein
a length in the axial direction of the cylindrical portion in the second opening is longer than a length of the peripheral edge of the first opening extending between the second openings adjacent to each other.

15-16. (canceled)

17. The discharge container according to claim 1, wherein
the length in the axial direction of the cylindrical portion in the second opening is longer than the length in the circumferential direction of the cylindrical portion in the second opening.

18. The discharge container according to claim 1, wherein
a width in the circumferential direction of the cylindrical portion in the second opening decreases toward the one side.

19-20. (canceled)

21. A discharge head attachment attached to a discharge head including a discharge port from which bubbles are to be discharged, the discharge head attachment comprising:
a cylindrical portion connectable to the discharge port on one side and including a first opening on another side; and
a porous portion provided on the one side of the cylindrical portion, wherein a side portion of the cylindrical portion includes a second opening, and
a peripheral edge of the first opening extends at least partially along a circumferential direction of the cylindrical portion.

22. (canceled)

23. The discharge head attachment according to claim 21, wherein
a mesh opening ratio of the porous portion is larger than 10%.

24. The discharge head attachment according to claim 21, wherein
an inner diameter of the cylindrical portion becomes smaller toward the porous portion on the first opening side than the porous portion.

25. The discharge head attachment according to claim 21, wherein
a flange protruding outwardly in the circumferential direction of the cylindrical portion is formed on the central side of the cylindrical portion in an axial direction.

26. The discharge head attachment according to claim 21, wherein
a plurality of the second openings are formed at intervals in the circumferential direction of the cylindrical portion.

27. (canceled)

28. The discharge head attachment according to claim 26, wherein
a length in the axial direction of the cylindrical portion in the second opening is longer than a length of the peripheral edge of the first opening extending between the second openings adjacent to each other.

29-30. (canceled)

31. The discharge head attachment according to claim 21, wherein
the length in the axial direction of the cylindrical portion in the second opening is longer than the length in the circumferential direction of the cylindrical portion in the second opening.

32. The discharge head attachment according to claim 21, wherein
a width in the circumferential direction of the cylindrical portion in the second opening decreases toward the one side.

33. (canceled)
